(19) United States
(12) Patent Application Publication
(10) Pub. No.: US 2006/0074701 A1
(43) Pub. Date: Apr. 6, 2006

(54) System and method of multi-account dynamic resource allocation via portable equipment

(76) Inventor: Win-Harn Liu, Taipei (TW)

Correspondence Address: HARNESS, DICKEY & PIERCE, P.L.C., P.O. BOX 8910, RESTON, VA, 20195, US

(21) Appl. No.: 10/953,455

(22) Filed: Sep. 30, 2004

(51) Int. Cl. G06Q 99/00

(52) U.S. Cl. 705/1

(57) ABSTRACT

In a method of multi-account dynamic resource allocation via portable equipment, a user inputs parameters and issues an execution command via the portable equipment after registration. According to the execution command, the server performs correspondent computation. According to the computation results and the parameters set by the user, resources are allocated and transferred to the correspondent account. The user thereby can interactively participate to the resource allocation and obtain in real-time feedback information from the server.

### BACKGROUND OF THE INVENTION

1. Field of Invention

The present invention relates to a system and method of allocating resources, and more particularly to a system and method of dynamically allocating account resources via portable equipment.

2. Related Art

As remote data exchange platforms such as mobile communication equipment platforms or website platforms are increasingly developed, it becomes possible to conduct most of social activities such as business, sales, entertainment, manufacture and management via a virtual panel. Many services based on such panel are bringing great changes to the human society, and reshaping people's living environments and living modes.

As the wireless technology progresses, portable wireless appliances such as palm computers or intelligent mobile phones act as an important role in the market of electronic products after the era of personal computers. Particularly, along with the combination of the mobile communication technology and the Internet, a vast variety of mobile handheld appliance emerges in the market. These handheld appliances usually are provided with wireless communication and inter-connection functionalities.

In addition to a user-friendly design of the handheld appliance, another important factor for the success for such handheld appliances to be widely accepted by customers is the investment of the network operator in the development of the network to provide the handheld wireless terminals with more functionality. According to the current trends, handheld appliances integrated with more and advanced functions will still be welcomer in future.

Presently, a portable wireless terminal is capable of analyzing users' data and allocating the available resources. For example, using a mobile phone to analyze data constitutes a static manipulation, the practical process that includes the following steps. The user of the mobile phone issues a word to the base station. The central processor unit of the base station receives the word and stores it in the database of a server of the base station. The organizing entity looks up the database according to selection rules to obtain corresponding mobile phone data. The data will then be recovered to the form of information of the user's mobile phone (the user's name or the mobile phone number). The user thereby can obtain specific data or participate in a lottery. However, this data analysis process usually is not coherent, and the user cannot obtain in real-time the result of the issue of his/her short message. As a result, the attractiveness and realism of the game is greatly impaired.

Therefore, there is presently an urgent need for a method of dynamically allocating resources via portable appliances, so that a user can interactively participate in the resource allocation and obtain in real-time feedback information.

### SUMMARY OF THE INVENTION

It is therefore an objective of the invention to provide a method of multi-account dynamic resource allocation via portable appliance that can overcome the prior problems and allows the user to interactively participate in the resource allocation and obtain feedback information in real-time.

To achieve the above objective, a system of multi-account dynamic resource allocation via portable equipment according to the invention comprises a portable wireless terminal and a server. The portable wireless terminal includes a register module for receiving account data inputted by the user, a parameter-setting module for receiving parameters set by the user, an executing module for receiving execution commands inputted by the user and a display module. The server further includes a resource receiving module for receiving user parameters corresponding to the account data, a computing module performing computation according to an execution command from the user, and a resource-allocating module for allocating resources according to an allocation ratio corresponding to the computing result and the parameters inputted by the user, and transferring the allocated resources to a corresponding account, respectively.

According to an embodiment of the invention, a method of dynamically allocating account resources includes the following steps. First, account data inputted by the user are received. According to the account data, a corresponding account is established at the server. Parameters inputted by the user then are received and stored. The user issues an execution command via the portable equipment. The server performs computation according to the execution command. According to the computation result and the parameters set by the user, the resources then are allocated and transferred to a corresponding account.

According to the system and method of the invention, the user can use portable equipment to interactively participate in the resource allocation and thereby achieve a dynamic resource allocation. Implemented in the course of a game process, the user can actively participate in the game, which increases the game attractiveness.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention can be fully understood from the detailed description given in the illustration below only, and thus doesn't limit the present invention, wherein:

FIG. 1 is a block diagram of a system of multi-account dynamic resource allocation via portable equipment according to an embodiment of the invention;

FIG. 2 is a flowchart of a method of multi-account dynamic resource allocation via portable equipment according to an embodiment of the invention; and

FIG. 3 is flowchart illustrating an implementation of the invention in playing a software game on a mobile phone according to an embodiment of the invention.

### DETAILED DESCRIPTION OF THE INVENTION

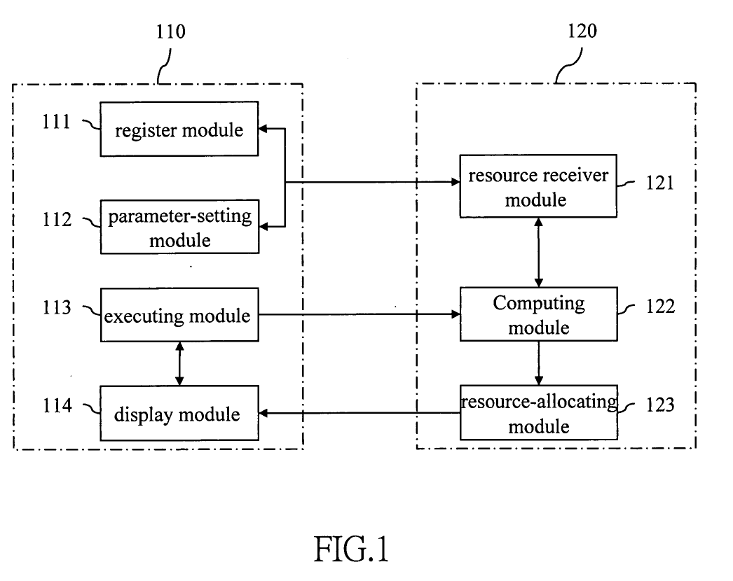

The invention provides a method and system of dynamically allocating a plurality of account resources via portable equipment. FIG. 1 is a block diagram of a system according to an embodiment of the invention. The system comprises a portable wireless terminal 110 and a sever 120. The portable wireless terminal 110 can be a mobile phone, a personal digital assistant (PDA), or a multimedia video, etc.

The portable wireless terminal 110 comprises a register module 111, a parameter-setting module 112, an executing module 113, and a display module 114. The register module 111 receives information data inputted by the user, including an account name, a password, fingerprint, a retinal print, or other identification data. The parameter-setting module 112 receives parameters set by the user, including game parameters. The executing module 113 receives execution commands inputted by the user, such as game start commands, etc. The display module 114 is used to perform displaying functions.

The server 120 includes a resource receiver module 121, a computing module 122, and a resource-allocating module 123. The resource receiver module 121 receives account parameters corresponding to the account information. According to the user's execution commands, the computing module 122 randomly selects icons and transfers them to the display module for displaying. The resource-allocating module 123 allocates resources according to the allocation ratio corresponding to the displayed icons and the parameters inputted by the user, wherein the resource can include a game fighting strength or power, a system resource, etc. The allocated resource then is transferred to the corresponding account.

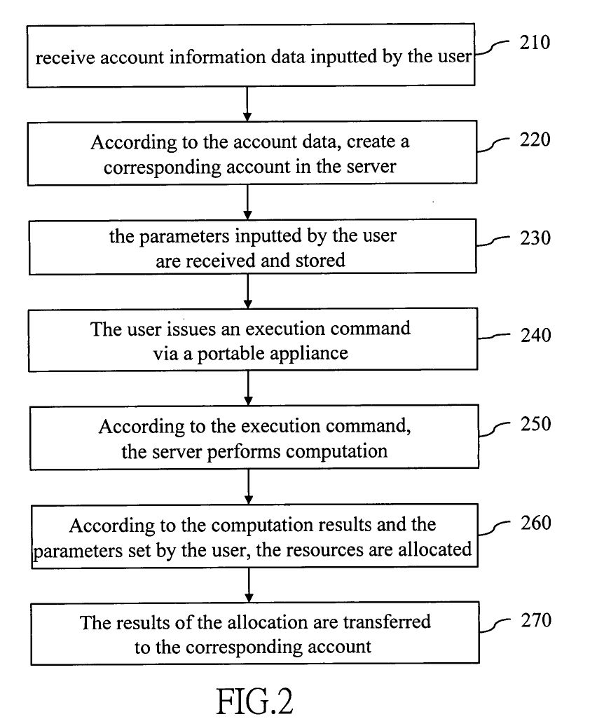

FIG. 2 is a flowchart of a resource-allocating method according to an embodiment of the invention. First, account information data inputted by the user are received (step 210). According to the account data, a corresponding account is created in the server (step 220), and the parameters inputted by the user are received and stored (step 230). The user issues an execution command via a portable appliance (step 240). According to the execution command, the server performs computation (step 250). According to the computation results and the parameters set by the user, the resources are allocated (step 260). The results of the allocation are transferred to the corresponding account (step 270).

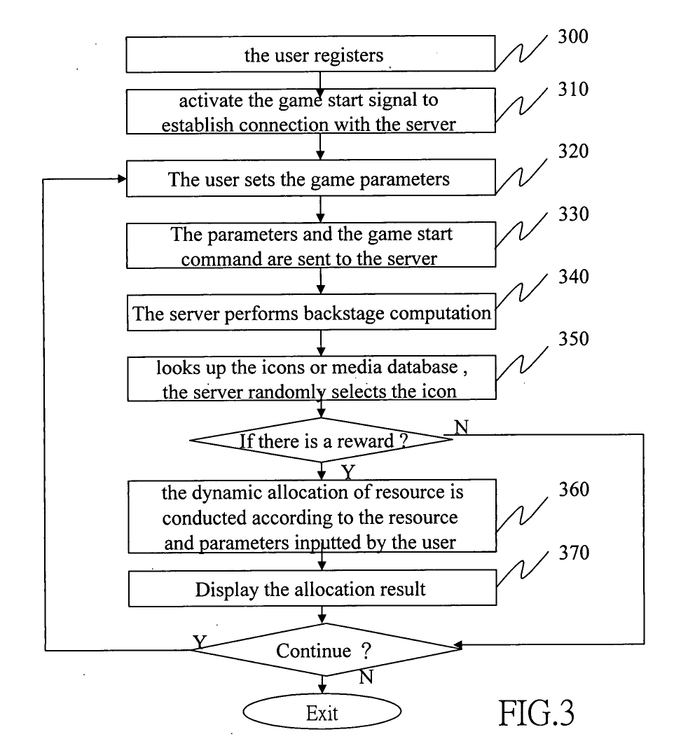

FIG. 3 is a flowchart of a resource-allocating method exemplary implemented in playing a game on a mobile phone. The first time this functionality is being used, the user has to register via his/her mobile phone (step 300). In this regard, account data are transferred to the server, which can include an account name and identification means. The identification means include a password, a fingerprint, a retinal print, etc. The organizing entity at the server's end receives and manages the user's registration information, and subsequently sets the corresponding game software in the server. Once the user has completed the registration, he/she can activate the game start signal to establish connection with the server (step 310). The system then performs an identification of the user, and requests, for example, the user's password, fingerprint, or retinal print for such identification. Once the user has passed the identification step, he/she can select the game matter and enter the corresponding game area. In the game area, the user can check at any time the status of the users online and the current integral context of every account, including the score, the reward amount, and the total resource assigned. The user then sets the game parameters, and decides the amount of resource to be allocated in the current game (step 320). The parameters and the game start command are then sent to the server (330). The server then performs backstage computation (step 340). According to the computation results, the system looks up the icons or media database; in the meantime, the user can visualize on his/her mobile phone the computing process, and the server then randomly selects the icon (step 350), and transfers the final icon to the mobile phone for display. The displayed icon indicates whether the user has won a reward in the game. If there is a reward, the allocation ratio is calculated, and the dynamic allocation of resource then is conducted according to the resource and parameters inputted by the user (step 360). For example, the assigned resources set by the users can be first collected. According to the reward, the user's resource ration is subsequently re-allocated. The reward resource can include a game fighting strength, an object reward, a counter, etc. The reward resource can also be a system resource. For example, if the user wins a reward, the server can allocate a system resource to the user according to the type of reward, such as the connection bandwidth, thus upgrades certain functions of the user's mobile phone, etc. The server transfers the allocated resource to the account, and sends the allocation result to the mobile phone for display (step 370). According to the image display, the user then acknowledges the reward result of the current game. The user thereby can receive feedback information in real-time.

It will be apparent to the person skilled in the art that the present invention as described above may be varied in many ways within the spirit and scope of the present invention. And the patent protection of the present invention is described in the attached patent claims.

What is claimed is:

1. A system of multi-account dynamic resource allocation via portable equipment, comprising:
a portable wireless terminal, including:
a register module for receiving account data inputted by a user;
a parameter-setting module for receiving parameters set by the user;
an executing module for receiving execution commands inputted by the user; and
a display module; and
a server, including:
a resource receiver module for receiving user parameters corresponding to the account data;
a computation module performing computation according to an execution command from the user; and
a resource-allocating module for allocating resources according to an allocation ratio corresponding to the computation results and the parameters inputted by the user, and transferring the allocated resources to the corresponding account.

2. The system of claim 1, wherein the parameters include a resource put in stake in a game.

3. The system of claim 1, wherein the execution commands include a game start command.

4. The system of claim 1, wherein the resources include a system resource.

5. The system of claim 1, wherein the account data include an account name and identification data.

6. The system of claim 5, wherein the identification data include a password, a fingerprint, or a retinal print.

7. A method of multi-account dynamic resource allocation via a portable equipment, comprising:
receiving account data inputted by a user;
according to the account data, establishing a corresponding account at the server;
receiving and storing parameters inputted by the user;
the user issuing an execution command via the portable equipment;
the server performing computation according to the execution command;
according to the computation results and the parameters set by the user, allocating the resources; and
transferring the allocated resources to the corresponding account.

8. The method of claim 7, wherein the parameters include a resource put in stake in a game.

9. The method of claim 7, wherein the execution command includes a game start command.

10. The method of claim 7, wherein the resources include a system resource.

11. The method of claim 7, wherein the account data include an account name and identification data.

12. The method of claim 7, further comprising the process to identify the user.

13. The system of claim 12, wherein user identification methods include password, fingerprint, or retinal print.
